(19) United States
(12) Patent Application Publication
(10) Pub. No.: US 2013/0250805 A1
(43) Pub. Date: Sep. 26, 2013

(54) METHOD FOR INVESTIGATING A DATA TRANSPORT NETWORK AND COMPUTER PROGRAM PRODUCT

(71) Applicant: Johannes Hansmann, Korschenbroich (DE)

(72) Inventor: Johannes Hansmann, Korschenbroich (DE)

(73) Assignee: Vodafone Holding GmbH, Duesseldorf (DE)

(21) Appl. No.: 13/779,967

(22) Filed: Feb. 28, 2013

(30) Foreign Application Priority Data
Feb. 28, 2012 (DE) 102012003977.8

(51) Int. Cl. H04L 12/24

(52) U.S. Cl. CPC H04L 41/12
USPC 370/254

(57) ABSTRACT

The present invention relates to a method for investigating a data transport network, the method comprising at least the following method steps: a) providing a network model, which contains at least network connections and network nodes as network elements and corresponds to an actually existing or a planned data transport network, and b) verifying the network model is hereby characterized in that in verifying the network model, at least one network-dividing section is cut through the network model and an analysis is conducted relative to the data traffic for at least a part of the network elements affected by the section. In addition, the invention relates to a computer program product for this method.

The invention relates to a method for investigating a data transport network, the method comprising at least the following method steps: (a) providing a network model, which contains at least network connections and network nodes as network elements and corresponds to an actually existing or a planned data transport network, and (b) verifying the network model.

In addition, the invention relates to a corresponding computer program product.

As is known, a network for transmitting or transporting data is composed of a plurality of processing units, which process data, conduct it into the network, receive or forward it. In the following, these processing units are called network nodes, net nodes, nodal points or just nodes. In order to transmit data between these network nodes, the network nodes are connected to one another by physical network connections, which are also called connections or links in the following. In this case, network nodes can be connected in different ways. The structure of the nodes and links with one another is called network topology, or just topology.

The topology of a network is decisive for its reliability. Here, it must be considered that a failure of individual or several network connections or network nodes may occur. Because of this, usually alternative network connections or network nodes are made available when designing the topology. In addition, among other things, the network topology essentially influences the data transmission capacity and the outlay for network equipment to be provided for the network and thus also the corresponding network costs.

For example, data transport networks form the basis in telecommunications networks, as transport networks in cellular wireless networks or even pure computer networks. In order to transmit data from one subscriber to another subscriber, network nodes, such as switching points, for example, are crosslinked with one another via network connections. Electrical or optical lines or wireless-based connections are used as physical network connections. A plurality of logic connections can be simultaneously established via a physical connection.

A method for planning and optimizing a data transport network is described in DE 10 2008 026 049 A1. It is assumed here that, in order to optimize planned or existing data transport networks, methods are known that optimally adapt the topology of a network and/or the provision of network elements to an expected data transfer volume between the individual network nodes. The topology and the incorporated network elements are optimally adapted to an expected or known data transfer volume by means of an optimizing method with the help of a network model of the planned or existing data transport network. In this way, an over-dimensioning of network connections or network nodes is avoided, in particular, and thus investment costs for the network are ultimately reduced.

This publication is also concerned with the circumstance that the reliability of an optimized network does not necessarily correspond to the asked-for requirements, since reliability also depends decisively on the topology of the optimized data transport network and this has not been considered at all or has only insufficiently been considered in the known optimizing methods for optimizing a network. In an actual optimized network, this can lead to unwanted blocking of data transmission when individual network elements fail.

A method for planning and optimizing a data transport network is proposed for this purpose in DE 10 2008 026 049 A1, with provision of a network model, optimizing the network connections of the network model by an optimizing method, and setting up and/or optimizing the data transport network corresponding to the optimized network model. Reliability is also determined in the method by means of executing an availability analysis for data transmission in the optimized network model with capacity requirements for the network connections using a given volume of data transmission in the optimized network model. In this way, data transmission capacities and data transmission volumes are considered. The availability analysis may contain, for example, a probabilistic method. In the case of unacceptable reliability, the optimized network model is either discarded or further refined.

In particular, an evaluation of the results of the availability analysis is proposed in the optimized network model according to the prior art, and new boundary conditions will be created if the evaluation results in an insufficient reliability. The new boundary conditions are then provided to repeat the optimizing of the network nodes and network connections by the optimizing method while maintaining these new boundary conditions.

A disadvantage of this known method is that the availability analysis and thus the evaluation of reliability are conducted on an already optimized network model.

In known failure analyses, usually one link and/or node is also selected from the network, and it is extensively verified whether the data traffic can still be transported via the links and/or nodes of the remaining network. These calculations last for a very long time and also only consider the failures of individual links. This calculation and, in particular, also the consideration of multiple failures, i.e., of cases in which more than one link or node fails, is not practicable in actual networks due to the long calculation time necessary for it. In particular, concrete bottlenecks of an actual network cannot be reliably localized or cannot be localized in a reasonable period of time.

The object of the present invention is thus to create a method for investigating a data transport network, which will also be called a network or net in the following, in which disruptions that are expected in the network can be recognized and taken into consideration during the verification of the network model.

The invention is based on the knowledge that this object can be accomplished by selecting a partial quantity of network elements and verifying the failure of individual or several network elements of this partial quantity. This verification can be combined with an availability analysis for verifying reliability.

According to the invention, this object is thus achieved by a method for investigating a data transport network that comprises at least the following method steps: (a) providing a network model, which contains at least network connections and network nodes as network elements and corresponds to an actually existing or a planned data transport network, and (b) verifying the network model.

The method is characterized in that in the verification of the network model, at least one network-dividing section is cut through the network model and an analysis is conducted relative to the data traffic for at least a part of the network elements affected by this section or cut.

The data transport network, which is also called a network or net in the following, in the sense of the invention, is understood to be a network that serves for transmitting or transporting data. The network can represent, for example, in particular, a telecommunications network, especially a wireless network or a computer network. Of course, the method according to the invention is not limited to these networks. For example, the investigation can also be conducted on other networks, such as, for example, networks involving street traffic management.

Investigation of a data transport network is understood to be verification and, if needed, a subsequent design of a network. The investigation involves both the verification of a new, planned, i.e., still non-existent network, as well as also the verification of an already existing network. The design of the network, which can be produced, if needed, subsequent to the investigation, can thus also comprise either the creation of a new network or the modification or improvement of an already existing network. Here, the individual network elements, in particular, both the network nodes as well as the network connections, which are also called physical connections or links in the following, are preferably included, i.e., selected as suitable and set up or modified.

The processing, guiding into network, receiving and forwarding of data traffic at nodes is called forwarding or transporting in the following for reasons of simplicity.

The verifying of the network model according to the invention may also comprise an optimizing of the network model based on the verification results. The optimizing preferably takes place only after the analysis relating to data traffic has been concluded.

The verifying of the data transport network according to the invention comprises the verifying of a partial quantity of the equipment for the network with respect to given or predetermined criteria. For this purpose, a network model is particularly used, which corresponds to the actually existing or a planned data transport network, i.e., reproduces the network connections (links) and network nodes (nodes), as well as their properties, such as, for example, their data transmission capacity, corresponding to the topology of the actually existing or planned data transport network.

The actual network equipment, i.e., in particular, network nodes and/or network connections, are designated in the following as network elements in the network model. Since these network elements correspond to the network equipment and the network model corresponds to the network, in the following, reference is made to the network model also as the network. Insofar as the actually existing or planned network is meant, the latter is called the actual network, if necessary, for clarification.

A criterion that is considered according to the invention in the verifying of the network is the data traffic, at least at the network elements affected by the section. The analysis of the data traffic according to the invention particularly relates to the analysis of the data traffic that cannot be transported or cannot be completely transported over the cut section. Here, data traffic is understood, in particular, as the data transfer volume, which is also called data transmission volume, traffic volume, quantity or amount of data or data volume. In the following, data traffic is also called traffic. The data traffic is transmitted in so-called requests that are also called demands. Here, each demand contains a specific amount of data transfer volume. The non-transportable or incompletely transportable data traffic is also called traffic loss.

The method according to the invention is characterized in that in the verification, at least one network-dividing section is cut through the network model, and an analysis is conducted relative to the data traffic for at least a part of the network elements affected by the section.

A section through the network model that divides the net into at least two, preferably into precisely two parts or regions, is called a network-dividing section according to the invention. The sections, which are also called cuts in the following, thus represent subdivisions of the network topology formed by the nodes and links. The position of the section, i.e., the network elements through which the section is made, is preferably selected so that it runs over network elements that have low availability. The section with the lowest total availability is also called the minimum section, minimum cut or min cut.

Network elements that lie in the section, i.e., through which or over which the section is made or cut, are preferably called network elements affected by a section according to the invention.

The analysis that is conducted relative to the data traffic for the network elements that are affected by a section according to the invention is an analysis relative to the availability of network elements and relative to the amount of data traffic that can be forwarded. In particular, it is verified whether a network element is available and if so, preferably also the amount of data that the available network element can forward. This amount of data traffic that can be forwarded by a network element is also called the capacity of the network element.

Different combinations of failures of the individual network elements are particularly preferably taken into consideration for a section in which more than one network element is affected.

By taking into consideration only a partial quantity of the network nodes contained in the network for the analysis in the method according to the invention, the time that is necessary for conducting the analysis can be considerably reduced, and the analysis can thus be conducted in a reasonable period of time. In particular, it is not necessary to consider every combination of failures of the network elements of the network.

Since beyond the simple cutting of a section, the network elements affected by the section will also be analyzed, a partial failure can be recognized also in the analysis relative to the data traffic, which would not be possible in a conventional cutting of a network-dividing section. A failure of at least one of the network elements is called a partial failure here, for which, however, there is still a residual capacity of the network elements. This residual capacity additionally can be extensively verified according to the invention as to whether it is sufficient for the transport of the expected data traffic. In the case of such partial failures, one or several network elements may have failed, i.e., physically failed and thus is/are no longer available or reachable. A physical failure of a network element, i.e., the non-availability in the sense of the invention is also simply called a failure.

In known availability analyses, only failures of network connections are considered, in which a transmission between nodes is no longer possible, i.e., the connection fails. In such cases, disturbances in which the transmission is only partially blocked are thus not recognized, since, for example, a residual capacity via a link that has not failed, is too small, although it is present. This residual capacity can be recognized, however, in the method according to the invention. Also, due to the analysis, bottlenecks in the network can be concretely localized in the method according to the invention.

Another advantage of the present invention consists in the fact that the verification proceeds based on the network model and here, the entire topology can be considered. In contrast to methods in which the requirements for individual network elements must be determined and verified individually, the method according to the invention is thus quicker and can be conducted with less computer power.

A network-dividing section is preferably made through network nodes and/or network connections. When compared with simply cutting a section through network connections, this approach is advantageous, since a failure may also occur in a node, while the connection over which the node is connected to other nodes is still available, if needed.

Nodes also possess their own failure probabilities and capacities. In the verifying of the network model, since nodes also are preferably considered, the investigation of the network is improved, and bottlenecks in data transmission can be reliably localized in a simple and reliable way.

Relative to the data traffic, the analysis preferably comprises the determination of the mean traffic loss, which is also called mean loss (ML) in the following.

In a network, traffic losses usually occur due to two different reasons. On the one hand, network failures can occur, in which the traffic can no longer be forwarded or can no longer be routed. On the other hand, blocks may occur, in which more capacity for data transfer is needed than is available.

A possible formula for determining a traffic loss (mean loss (ML)) as the combination of the above two named reasons for the traffic loss, namely the failure of network elements and the blocking of network elements is given by the present invention. In contrast to known algorithms for the calculation of network availabilities, in which the probability is estimated that all or several nodes of a network are connected, with the present invention, it is possible to combine the probability of failure scenarios with the traffic volume of other network elements that is modified thereby, in particular in the section in which the network element(s) affected by the failure lie, in order to be able to find availability bottlenecks of nodes and/or links as well as capacity bottlenecks in combination with one another. It has been shown that the mean loss is suitable as information both for failures of network elements as well as for available capacity. Therefore, in the method according to the invention, by means of determining a value for mean loss, taken into consideration, in particular, is both the traffic that can no longer be transported in the case of a failure of a network element as well as the traffic that can no longer be transported for lack of sufficient capacity or residual capacity of one or more of the network elements. Particularly preferred, the mean loss is not calculated or determined for an individual network element, but is determined as a value for all network elements in one section. A dependence of the overload and thus of the blocking of individual or several network elements is hereby considered in the case of failure of one or more network elements.

Mean traffic loss, which is also called mean loss (ML), according to the invention is understood as the traffic volume or data volume or the quantity of traffic or quantity of data that cannot be transported due to failure or blocking, multiplied by the probability of occurrence of this loss.

Particularly preferred, the mean traffic loss (mean loss) is checked against a reference value, in particular, compared with a reference value. The reference value is preferably a predefined value. This value is preferably further defined for the entire network. Since an absolute consideration of mean loss values, which are determined for individual network elements, is not necessary, but in the case of this embodiment, only a comparison is needed, i.e., the checking of a relation of the determined value to the reference value is sufficient, the analysis according to the invention is further simplified. Also, bottlenecks in the net can be reliably localized by limitation to a maximum value of mean loss.

According to one embodiment, in the analysis of the data traffic, the failure of at least one network node in the section and/or of one network connection in the section is considered. Particularly preferred, all possible combinations of failures of one or more network elements in the section are considered. For each of these combinations, the data traffic and, in particular, the traffic loss, in the form of the mean loss, can then be determined. By preferably comparing with a reference value, those combinations in which the mean loss is too great can thus be determined. Particularly preferred, in this case, the network elements considered as failed are also recognized for this combination. In addition, the affected data traffic that can no longer be transported can also be recognized. Thus the bottlenecks both with respect to availability as well as relative to (residual) capacity can be reliably localized in each section.

According to one embodiment, in the analysis, in addition to the failure of at least one network element, the capacity of at least one other network element in the section is considered after considering one or more failures. Here, the quantity of data transfer volume that a network node or a network connection can forward is especially designated the capacity of the network element. The capacity thus preferably represents the residual capacity of the network element, i.e., the capacity that is still not occupied by the already expected data traffic.

After producing a section, the failure probability and capacity of the participating network elements are preferably determined and the data transfer volume over the section is calculated. The produced section serves as a basis for investigating partial failures, in which the participating network elements in all combinations are considered available or failed. The probability of such occurrence and the blocked traffic volume is determined for each case.

By considering the residual capacity in addition to the failure and, in particular, after taking into account the failure or the failures, it can be determined whether, after the failure of one or more network elements, the network elements that are still available in the section are sufficient for the forwarding of the data traffic. If this is not the case, despite the availability, i.e., the non-failure of these residual network elements, the traffic is to be evaluated as lost traffic, i.e., non-transportable traffic. This can be considered in the analysis of the data traffic in which the mean loss is determined by incorporating this loss in the value of the mean loss.

Preferably, the cutting of a section is conducted after weighting the network elements. By weighting the network elements, i.e., the nodes and/or links, an individual consideration of all links and/or nodes present in the network model is not necessary. In the weighting, for example, the network elements are grouped in regions, in which network elements are then contained that fulfill a common criterion.

According to one embodiment, the section is cut after a weighting of the network elements relative to their failure probability. Here, the network nodes and/or network connections can be identified whose failure probability is highest and whose availability is thus lowest. If the sections are cut after such a weighting, then sections are obtained that are close to the minimum cut. Since in the method according to the invention, after cutting the section, however, in addition, an analysis is conducted relative to data traffic, bottlenecks that are caused by a capacity bottleneck can also be found in the network in the method according to the invention.

According to another embodiment, the section is cut after a weighting of the network elements relative to a deviation from a mean value of the failure probability of the network element. The deviation can be determined as the difference between a regression line that represents a mean value, and the actual value. By determining the deviation from the mean value of the failure probability and using this for the weighting of the network elements, it is possible to produce additional sections, in which an analysis can then be made in turn relative to the data traffic. By cutting further sections, apart from the sections that are cut by means of weighting according to failure probability, the method according to the invention and, in particular, the recognition of bottlenecks, can be further improved, without considerably increasing the required time and calculation expenditure.

According to another embodiment, the section is cut after a weighting of the network elements relative to a deviation from a mean value of the capacity of the network elements. Such deviation can also be determined as the difference between a regression line that represents a mean value and the actual value. Further sections can be cut in this case, which would not be found or would not be cut with a simple consideration of the failure probability or of the deviation from a mean value of the failure probability. In addition, according to the invention, an analysis relative to the data traffic is also provided for these sections. Thus, the recognition of bottlenecks in the net can be further improved by the additional sections.

In this weighting, according to one embodiment, reciprocal residuals for the capacity, and according to an additional or alternative embodiment, reciprocal residuals for the failure probability are used. Here, the failure probability is preferably expressed by the negative logarithm. This is advantageous, since in a section, the capacities are added, but the failure probabilities are multiplied. By using the logarithm, this multiplication will be turned into addition. Thus, it is achieved that a section with a probability proportional to the product of the individual failure probabilities will be selected or cut.

Preferably, the analysis of the network elements affected by the cut section is made in an iterative process. For example, a method for determining network availability can be integrated with this method or combined therewith. In the individual iterations, preferably all possible combinations of failures of the network elements lying in the section are hereby considered individually. A reliable localization of bottlenecks can be provided in this way. In particular, a method in which the availability of the network nodes and/or network connections is used is designated as a method for determining the network availability. According to one embodiment, in the determination of the network availability, for example, the links in a network model are weighted with the negative logarithm from the failure probability thereof, and subsequently a link proportional to its weighting is selected, the nodes at the end of the link are connected together, and the links lying in between are deleted. This method is repeated recursively until only a few nodes remain. Subsequently a network-dividing section is cut. In such a method, according to the invention, the verification of the network model is incorporated iteratively. By iteratively incorporating the consideration of the individual possible combinations of failures in a section, all possible combinations of failures in each of the sections produced can be considered.

According to another embodiment, the method comprises the further step of setting up and/or adapting the data network corresponding to a network model that will be optimized on the basis of the verification results that were obtained by the verification according to the invention, in particular, based on the analysis result relative to the data traffic. Here, a creation of an actual new network will be referred to as a setting up. A change in an actually existing network will be referred to as adapting. The setting up and/or adapting is produced here corresponding to the optimized network model. For example, individual network nodes and/or network connections are replaced here by new, more reliable network elements, or corresponding network elements with a higher capacity are selected and exchanged or incorporated, if needed. The network elements to be replaced or to be exchanged and the necessary capacities are determined and identified by the analysis according to the data traffic.

The verification of the network model according to the present invention, based on which the actual network is adapted and/or set up, in particular, represents an addition and/or a removal of network connections and/or network nodes. Also, by changing the capacity of network connections and/or network nodes, i.e., selecting a network element with a higher capacity for the data traffic transport, an optimization is provided in the method according to the invention. The planned or actually existing network can be set up or adapted corresponding to the thus optimized network model.

In addition to simply investigating a network, a subject of the present invention is thus also the setting up and/or the adapting of the network.

For example, with the method according to the invention, a wireless network, i.e., a data transport network in a wireless network for transmitting data, can be investigated, and, if needed, can be set up or adapted based on an optimized network model. Wireless networks primarily serve for the transport of data between subscribers or between service providers and subscribers. An investigation and, if needed, an optimization of existing or planned data transport networks according to the method of the invention is advantageous both for a user as well as for an operator of a wireless network, since reliable data transmission is achieved with minimally necessary means.

The method according to the invention can be implemented by means of software and/or hardware.

According to another aspect, the invention relates to a computer program product, with a program medium readable on a computer, which, when the program is loaded, has program means for conducting the method according to the invention. A program that comprises instructions that are designed in order to execute the method according to the invention is also a subject of the present invention. A computer-readable medium, on which a program is stored, whereby for this purpose, the program causes the computer to execute the method according to the invention, is also a subject of the present invention.

The computer program product can be stored and executed, for example, on a computer device, particularly a server. The computer program product can be loaded, for example, from a memory device, from the internet or the like, on or in the computer device, e.g., computer or server. A suitable memory device, for example, can be characterized in that the method steps of the method according to the invention as described above are integrated in program means stored in the memory device. As the memory device, for example, conventional storage media can be provided, which, due to the program means, or due to the software, however, embody a particular functionality, by means of which they differ from the known storage media in the particular way of the present invention.

In the computer program product according to the invention, it is particularly of advantage that based on the improved method, the times for determining bottlenecks and the computer power associated therewith are reduced. Also, the results that can be output from the computer program product or the program executed by it, for example, the failed network elements and the failed demands are suitable as initial quantities for optimizing the network model.

Advantages and features that are described relative to the method according to the invention, are thus valid—insofar as they are applicable—also for the computer program product, and vice versa.

Thus, a possibility for determining bottlenecks and weak points in a network is provided with the present invention. In this case, in particular, capacitive bottlenecks in a network are also sought or are determined. Building upon this, an optimization of the network, for example, by increasing the capacities of individual or several network elements and/or an optimized/modified crosslinking of the network nodes can then be achieved.

Not only the failure probability, but also the capacity or the traffic concentration of the data, i.e., the traffic, is hereby considered according to the invention. The result of the verification of the network model used according to the invention can be a calculated traffic loss, information of failed network elements and/or information of affected data traffic, which is identified, in particular, as requests or demands. A targeted adaptation of links and/or nodes is possible with these results.

The core of the invention is, on the one hand, that sections are verified relative to the influence of partial failures. In addition, the core of the invention is that the sections are produced in different ways i.e., different criteria are applied for the cutting of sections. In particular, sections additional to the already known sections are produced after a weighting of the network elements according to their failure probability.

The invention will be explained in more detail in the following, again with reference to the appended figures.

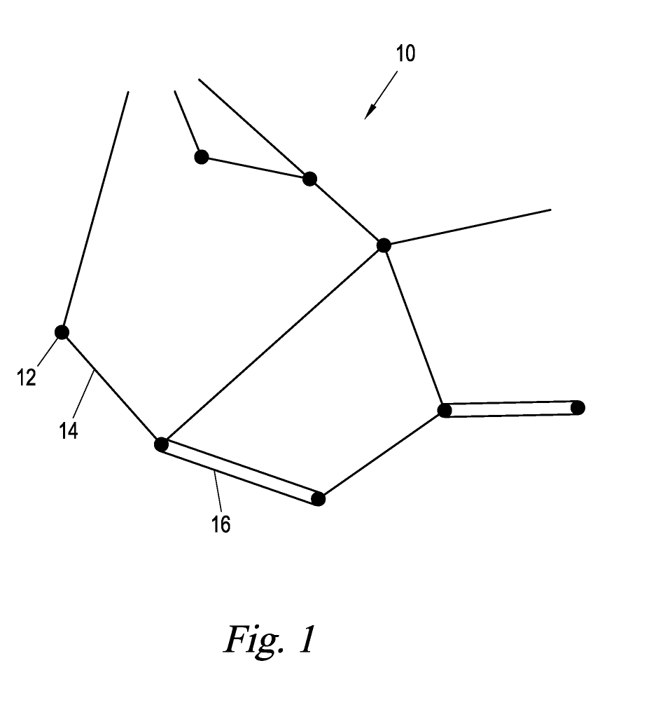

FIG. 1 shows a schematic representation of a network model of a data transport network with network connections and network nodes.

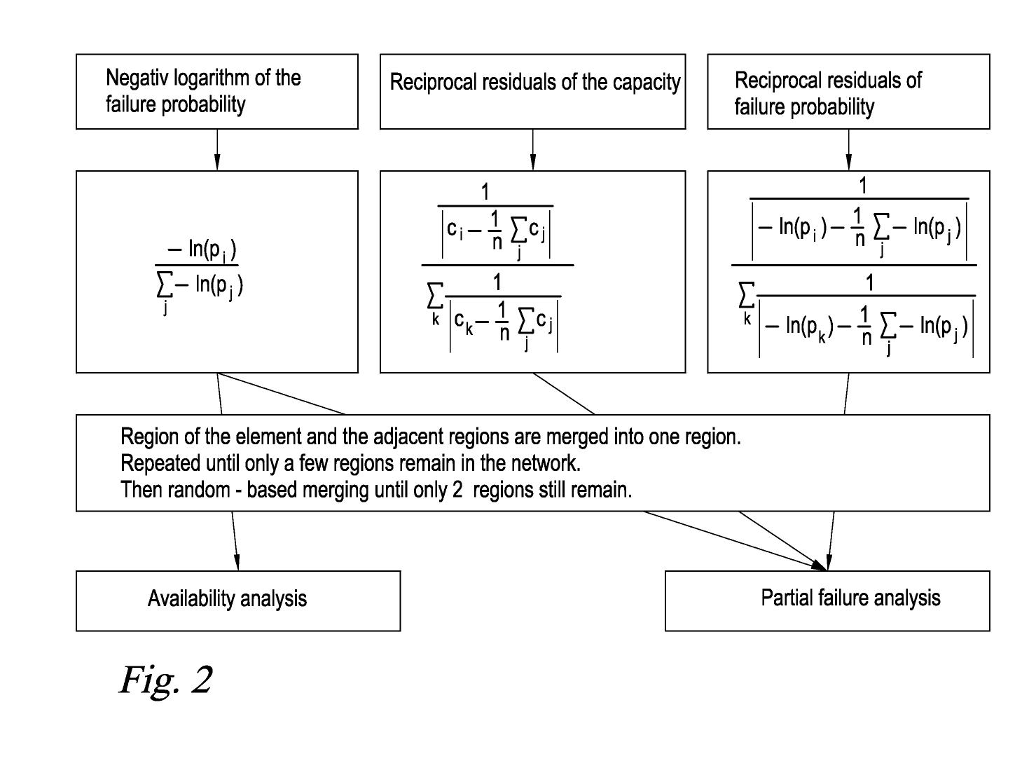

FIG. 2 shows a schematic representation of a cycle for producing sections according to an embodiment of the method according to the invention.

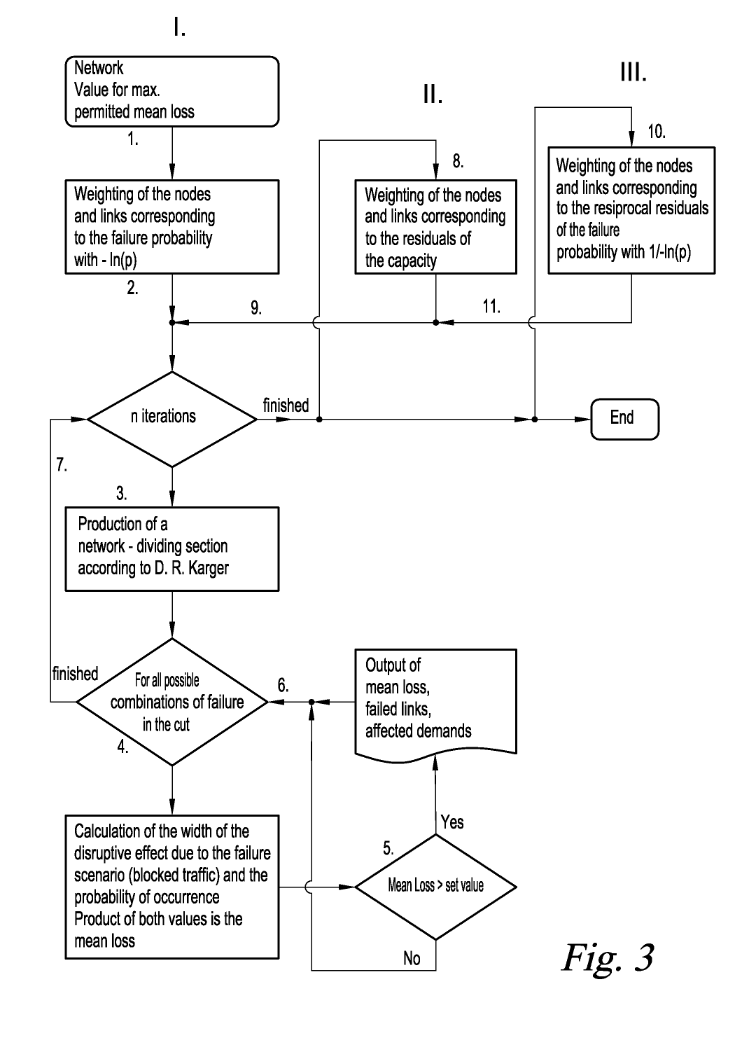

FIG. 3 shows a schematic flow chart of an embodiment of the method according to the invention.

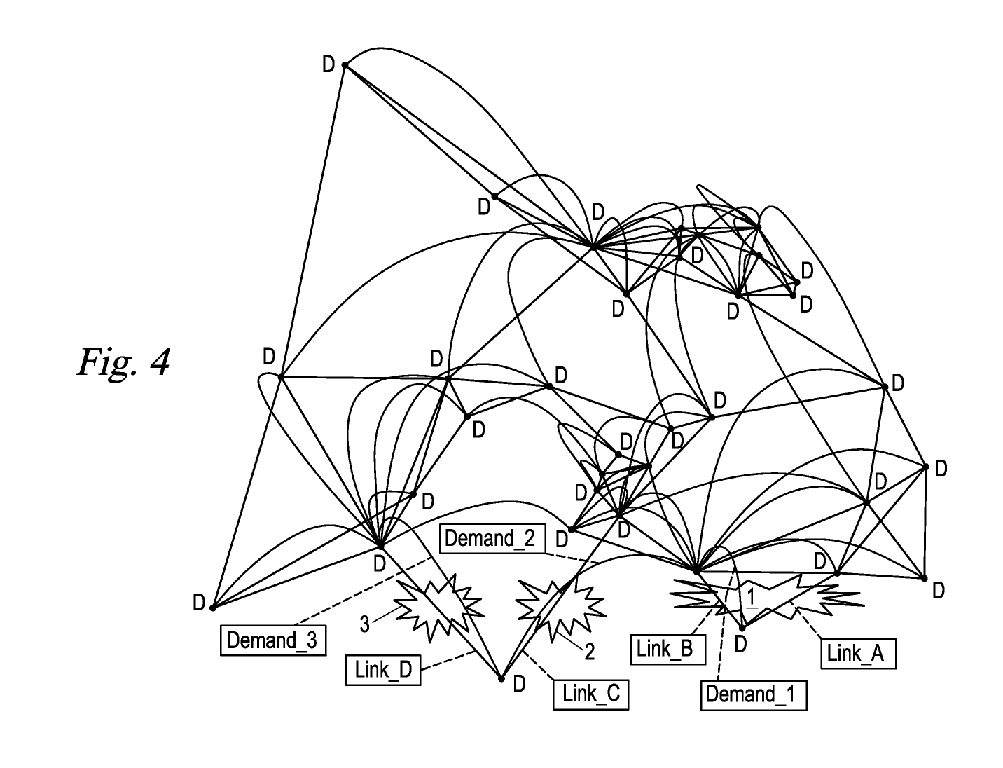

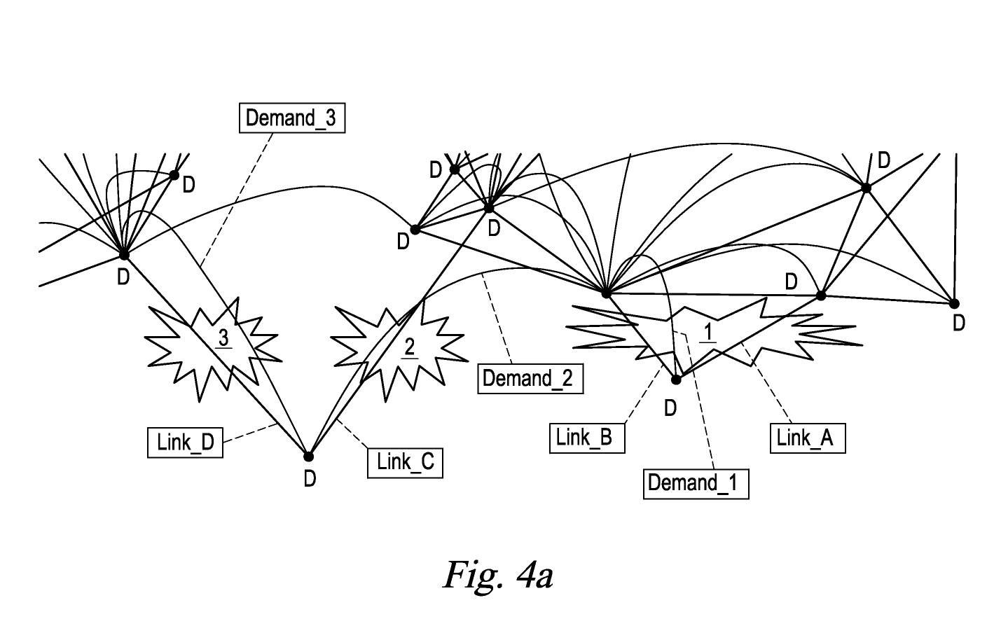

FIG. 4 shows a schematic representation of a network with cut sections and FIG. 4a shows a detail view of the lower region of the network of FIG. 4.

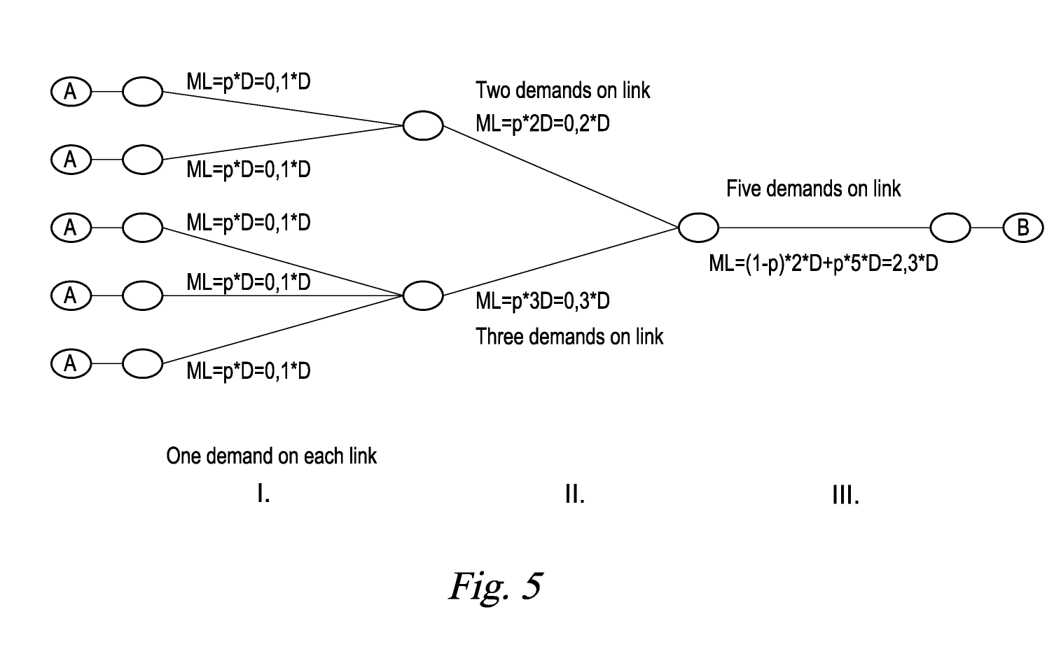

By way of example, FIG. 5 shows the effects of individual link failures in a tree structure.

In FIG. 1, a data transport network 10, which is also called a network or net in the following, is shown schematically. The network 10 contains network nodes 12 shown as points. STM1 network connections 14 and E1 connections 16, which are illustrated as lines, are provided between the network nodes 12. The STM1 network connections and E1 connections 16 represent connections or links in the sense of the present invention and are known to the person skilled in the art from the ITU-T (International Telecommunication Union-Telecommunication Standardization Sector) standardized connections for digital telecommunication. An E1 connection transmits approx. 2 Mbit/s, while a more rapid STM1 connection manages approx. 155 Mbit/s. In the two types of connection in this example, the data are transmitted digitally in small data packets, which are also called cells.

According to one example for clarifying the basis of the invention, one assumes that data traffic, which is also referred to as requests (demand (D)) in the following, is transported over a number of (n) parallel, disjunctive connections (links) with a link failure probability (p). If all these links fail, the entire data traffic, i.e., all the demands are lost. This scenario is like a section, which is also called a cut, at which a network is subdivided into two parts. The mean traffic loss can be calculated on such a cut (ML_{cut}) according to formula (I).

ML_{cut}=D*pⁿ (1)

In this case, only a single failure scenario is considered, i.e., for several links in the cut, only the scenario in which all links fail is considered. This first calculation thus does not consider the influence of a partial link failure of a link group, however, i.e., of the links in the cut. The mean loss (ML) of such partial failures can be introduced with the limitation that it proceeds from identical failure probabilities and capacities for each link.

Again in this case, a demand (D) must be transported over a number (n) of parallel or unconnected links; this time, of course, with the common capacity (C) and a link failure probability (p). The mean traffic loss can be calculated for each scenario, in which (i) links fail. Overall (n!/i!/(n−i)!) different scenarios exist, in which precisely (i) links fail. The range of the number of failed links (i) varies from 0 (no link has failed) to (n) (all parallel links have failed). In one failure scenario, then no mean traffic loss occurs, if the remaining capacity exceeds the data volume, i.e., the demand. Equation (2) shows one possibility for calculating the sum of all mean traffic failure mean loss (ML) scenarios.

$$ML = D * {\sum }_{i = 0}^{n} \\ \{ \begin{matrix}( 1 - \frac{( n - i ) * C}{n * D} ) * {p}^{i} * {( 1 - p )}^{( n - i )} * ( \begin{matrix}n \\ i\end{matrix} ) … for D >= \frac{n - i}{n} C \\ 0 … otherwise\end{matrix} \} \qquad ( 2 )$$

The estimating error in a section with variable capacity and availability can be determined as follows. The availability and capacity of the links in a cut may deviate from identical parameters. The influence of varying parameters can be shown as follows. For this, a series of sections with varying random-based link capacity and varying failure rates can be produced. Here, the following limitations are made:

The number of links (n) is constant for each cut in the analysis.
The product of the random-based link failure probabilities is constant for all cuts.
The sum of the link capacities (C) is constant for all cuts.
The demand (D), which should be transported over the cut, is constant for all cuts.

Such a calculation is unsatisfactory, of course, since the calculated mean loss from (1) and from (2) is not usable, if the capacity and the failure probability vary among the links. The mean loss can increase to an extreme extent due to the capacity and failure probability, even if these scenarios are not very frequent.

It has been shown that an appropriate adapting of the estimation of the mean loss considers the calculation according to (1) as well as an adapting of (2), by calculating partial failures, whereby the exact capacity (cᵢ) and a failure probability (pᵢ) of one of the links is considered, and identical capacities (C/n) and a failure probability (p) are considered for the other links at the same time. This calculation is conducted until each link has been considered once with the exact values. The influence of each link is considered thereby, without the need for calculations for each combination of failure events. Equation (3) shows such an adapting. Here, MLₗᵢₙₖ is the sum of the mean loss for a series of failure scenarios.

$${ML}_{link} = {\sum }_{j = 1}^{n} {\sum }_{k = 0}^{n - 2} \{ \begin{matrix}( D - ( C - {c}_{j} - k * \frac{C}{n} ) ) * \frac{{p}_{j} * {p}^{k}}{( k + 1 )} * ( 1 - \frac{{p}^{n}}{{p}_{j} * {p}^{k}} ) \\ if … \leq C - {c}_{j} - k * \frac{C}{n} \leq D \\ 0 … otherwise\end{matrix} \qquad ( 3 )$$

In order to consider the influence of the change in capacities and the failure probabilities in cases with more than one link failure, preferably the deviation of the link failure probability from the corresponding failure probability (σₚ), the deviation of the link capacity from the corresponding capacity (σₛ), and the deviation of the product of link failure probability and capacity relative to their corresponding values (σ_{pc}) are used. By combining and weighting these deviations as shown in ML_{dev} (4), these can be added to the mean-loss sum calculation of MLₗᵢₙₖ (3).

$${σ}_{p} = \sqrt{\frac{{\sum }_{j = 1}^{n} {( {p}_{j} - p )}^{2} n}{n}} \\ {σ}_{c} = \sqrt{\frac{{\sum }_{j = 1}^{n} {( {c}_{j} - \frac{C}{n} )}^{2}}{n}} \\ {σ}_{pc} = \sqrt{\frac{{\sum }_{j = 1}^{n} {( {c}_{j} * {p}_{j} - \frac{C}{n} * p )}^{2}}{n}} \\ {ML}_{dev} = ( {σ}_{pc} - {σ}_{p} * {σ}_{c} ) * {( \frac{D}{C} )}^{2} * \frac{p}{n} \qquad ( 4 )$$

Additionally, a mean loss should preferably be considered, in which no link fails, in cases in which the demand exceeds the total capacity. This can be calculated, as described in (5):

$${ML}_{0} = \{ \begin{matrix}( D - C ) * ( 1 - {p}^{n} ) … if … C < D \\ 0 … otherwise\end{matrix} \qquad ( 5 )$$

Here, ML₀ is again the mean loss of a single failure scenario.

By combining all these mean loss calculations from (1), (3), (4) and (5), the sum of the mean losses, as shown in (6), can be adapted.

ML_{adapt}=ML₀+ML_{Link}+ML_{dev}+ML_{cut} (6)

Here, ML_{adapt} is again the sum of the mean loss for a series of failure scenarios.

It has been shown that the result of the adapted mean loss calculations from (6) agrees rather well with the exact values of the losses.

In order to determine the network availability, the availability of a network can be calculated. There are different algorithms, which look for bottlenecks of the connection in a network. Of course, these only look for network-section failures and not for capacity bottlenecks in connection with failures.

The above-given adapted mean loss ML_{adapt} in contrast considers both the capacity as well as the failure probability. If an algorithm searches for the maximum mean loss instead of for sections with the maximum failure probabilities, the bottlenecks of capacity and redundancy in a network can thus be found. This can be produced by the method according to the invention.

A possible method for determining availability, which can be applied in the method according to the invention, for example, uses an availability algorithm, which generates network sections (cuts), by random-based methods, which converge on cuts with minimum availability. An advantage of the use of these random-based algorithms is that, in a simple way, knowledge of the critical cuts/links and the affected data traffic, i.e., the affected demands, can be obtained in a network during the availability calculation. If the convergence from the maximum failure probability to the maximum mean loss is adapted in a network, then, according to the invention, bottlenecks can be determined in a simple way.

A relatively faster random-based algorithm for the network availability determination that can be used according to the invention was published by D. R. Karger (A Randomized Fully Polynomial Approximation Scheme for the All Terminal Network Reliability Problem, Karger, David R., SIAM Journal on Computing 29 (2), 1999 (pp. 492-514)), which is incorporated herein by reference.

Here, each link in the network is weighted with the negative logarithm of its failure probability. Then a link is selected proportional to its weighting and the nodes are combined at the ends, and the links lying in between are deleted. Subsequently, this method is repeated until several steps prior to the state in which two nodes remain are achieved. Then each section is selected through the remaining nodes with uniform probability in order to obtain a section close to the minimum section (min cut) (network-dividing section with minimum availability). By applying this cycle very often, the min cuts and other cuts with a high failure probability are obtained as results.

As shown above, the mean loss is also defined by variation of the capacity and availability of the participating links. Thus, it was assumed from this in the invention that it is insufficient to produce cuts proportional to the link failure probability, since the individual link capacity is not considered and identical parameters are assumed in the section.

Thus, according to the invention, preferably all links of a cut are verified in the availability calculation for the influence on partial failures, since the mean loss estimation does not recognize the individual bottleneck. This is conducted in the method according to the invention by the analysis of the network elements relative to data traffic. Also, according to the invention, new sections are preferably produced, where regions proportional to the reciprocal residuals of the failure probability (negative logarithm) and to the reciprocal residuals of the capacity are combined. These additional sections are also verified according to the invention for the influence on partial failure, i.e., an analysis relative to the data traffic is carried out on these sections. The additional production of sections can be based on the above-named algorithm according to D. R. Karger, of course, with adapted selection probabilities. Tests with further production of sections based on reciprocal residuals of the product of capacity and failure probability (again negative algorithm) have led to no new sections, so that any further production of sections can be dispensed with according to the invention. All sections produced were investigated with respect to partial failure and its influence on a mean loss. A partial failure is normally a part of different sections, but only the partial failure and the maximum mean loss are recorded for this analysis.

If it is assumed that a network without any traffic loss operates in the case of no failures in the network (ML₀=0) from (5), there are now three different types of production of sections, but only the sections that were produced proportional to the failure rates are considered for the network availability calculation. In contrast, preferably these and all other sections are used in the method according to the invention, in order to localize bottlenecks in the network by verifying partial failures in the sections according to the invention.

A cycle of producing sections, in which the three types of section production are indicated, is shown in FIG. 2. In all three types, the element i is selected proportional to the criterion of the respective type of section production and represents its own specific region.

In the type of section production indicated in FIG. 2 left, the negative logarithm of the failure probability is selected as the criterion. The result of this type of section production can then be introduced into the availability analysis. This is already known, for example, relative to the method according to D. R. Karger.

In the types of section production shown in FIG. 2 in the center and at the right, on the one hand, the reciprocal residuals of capacity, and on the other hand, the reciprocal residuals of the failure probability are used as the criterion for the producing sections.

The results of these two types of section production as well as also the result of the section production according to the type of section production shown on the left can be used for the partial failure analysis described according to the invention.

The course of one embodiment of the method according to the invention that also illustrates this cutting of sections is shown schematically in FIG. 3.

In a first method part I at first in step 1, a value for the maximally permitted mean loss for the network is predetermined. In step 2, a weighting of the nodes and/or the links corresponding to their failure probability is carried out on the network model. The weighting is produced by means of the negative logarithm −ln(p). An iteration loop is subsequently run through. In this, a network-dividing section is produced according to step 3. This method, for example, corresponds to the above-named method that was proposed by D. R. Karger.

Subsequently, the analysis of the data traffic corresponding to the present invention is now conducted. For this, in step 4, a disruptive effect width due to blocked traffic and due to the probability of occurrence of failure is determined for all possible combinations of failures in the thus-cut section. The product of these two values produces the mean loss. In step 5, the thus-determined mean loss is compared with the predetermined maximally permitted value. Here, if an exceeding of the set value is recognized, then an output of the mean loss value is produced, as well as also, preferably, of the failed links and the affected data traffic, i.e., the affected demands. Subsequently (step 6), the algorithm returns to step 4 until all possible combinations of failures have been considered. Then the next iteration is started via step 7 until a predetermined number of iterations (n) have been passed through. After this, method part II is started. Here, in step 8, a weighting of the nodes and/or the links is set corresponding to reciprocal residuals of the capacity. The nodes and/or links weighted in this way are introduced into the iteration loops described in method part I and correspondingly further processed. After the end of the iteration loops, method part III starts, with which the weighting of the nodes and/or links corresponding to reciprocal residuals of the negative logarithms of the failure probabilities, is set up in step 10. In turn, the newly weighted nodes and/or links are introduced into the iteration loops and correspondingly further processed. After terminating these last iteration loops, all potential bottlenecks in which the mean loss is exceeded are known via the output.

In the prior art, only link failures are considered in network availability algorithms and the mean loss analysis. According to the invention, however, node failures and node capacities can also be considered.

For this purpose, according to the invention, explicit source and target nodes that are connected with the network without a failure probability (pᵢ=0) and with a very high capacity (cᵢ), can be selected. Like the links, each node also has a failure probability and a specific capacity. If the method according to the invention is started, each link and each node is set relative a failure status and represents its own specific region. Then the method proceeds as before, the nodes being selected and set as available, corresponding to the setup of the links. All connected available nodes are set up over available links, so that they are in the same region. If only two regions remain, a section is produced.

FIG. 4 shows a network wherein the straight lines represent the links and the curved lines represent the demands, i.e., the data traffic. This example comprises 35 nodes, 78 links and 48 demands. A detail view of the lower region of the network of FIG. 4 is shown in FIG. 4a. If a maximum permitted mean loss is predetermined for this network (here, e.g., ML>0.4), (partial) failures can thus be sought that have a mean loss of greater than 0.4. In the example shown, it proceeds from a failure probability from one link of 0.0001, from one link of 0.01 and one link of 0.001. The failure probability for each node was set to 0.

In this way, 3 cuts with a mean loss of more than 0.4 were found by means of the example of embodiment of the iterative process according to the invention, which is given in FIGS. 2 and 3. These are shown by stars in FIG. 4. The capacity of the links was given as 350,000 in each case. The data traffic (demand) was assumed in the range from 0 to 350,000, and 75,613 on average. The failed elements, the failed or lost demands, as well as the mean loss resulting from the failure probability and the actual lost data traffic are indicated below.

Three whole or partial failure scenarios were found, which have a mean loss of more than 4.00e-001.

1^{st} failure scenario: probability = 1.000000e−005

| | |
|---|---|
| Failed element: Link_A | Capacity: 350,000 |

Failure probability: 1.00e−003

| | |
|---|---|
| Failed element: Link_B | Capacity: 350,000 |

Failure probability: 1.00e−002

| | |
|---|---|
| Failed demand: Demand_1 | Traffic: 42,620.00 |

Mean traffic loss through section: 0.426200
2^{nd} partial failure scenario: Probability = 1.000000e−004

| | |
|---|---|
| Failed element: Link_C | Capacity: 350,000 |

Failure probability: 1.00e−004

| | |
|---|---|
| Partially failed demand: Demand 2 | Traffic: 350,000 |
| Partially failed demand: Demand 3 | Traffic: 5,039.00 |

Mean traffic loss: 0.503900
3rd partial failure scenario: Probability = 1.000000e−004

| | |
|---|---|
| Failed element: Link_D | Capacity: 350,000 |

Failure probability: 1.00e−004

| | |
|---|---|
| Partially failed demand: Demand 2 | Traffic: 350,000 |
| Partially failed demand: Demand 3 | Traffic: 5,039.00 |

Mean traffic loss: 0.503900

As can be derived from these results, the partial failure scenarios 2 and 3 would not be found by a method that does not investigate partial failures in the sections as does the method according to the invention, since the failure probability thereof is in fact high in each case, but from a detour of the traffic, for example, in the case of a failure from link_C to link_D or vice versa, or would have proceeded over the links connecting at the top to links C and D in FIG. 4 and thus no section would have been present.

FIG. 5 shows by way of example the mean loss in a tree structure for individual link failures. In this case, it proceeds for each source A from the same demand D to the target B. Here, the same capacity C and failure probability p were assigned to each link.

If one proceeds from p=10% and D=C/3 and searches for scenarios in which the mean loss is greater than 0.25*D, then one obtains the result shown. In this case, multiple failures were not considered.

In the stage characterized by I, there is still no problem, since only one demand is present on each of the links. In stage II, the maximum permitted mean loss value is reached for three demands on the lower link. In the case of only two demands on the upper link, in contrast, the maximum permitted mean loss is still not reached. In stage III, the mean loss setting of ML<0.25 is then no longer fulfilled, since five demands are concentrated on this link. In this case, two demands are always blocked, since the capacity is insufficient and the additional demands are blocked, if the link fails.

### LIST OF REFERENCE CHARACTERS

10 Network
12 Network node
14 Link
16 Link

1. A method for investigating a data transport network that comprises at least the following method steps:
a) providing a network model, which contains at least network connections and network nodes as network elements and corresponds to an actually existing or a planned data transport network, and
b) verifying the network model is hereby characterized in that in verifying the network model, at least one network-dividing section is cut through the network model and an analysis is conducted relative to the data traffic for at least a part of the network elements affected by the section.

2. The method according to claim 1, further characterized in that the section is cut through network nodes and/or network connections.

3. The method according to claim 1, further characterized in that the analysis relative to data traffic comprises the determination of the mean traffic loss (mean loss).

4. The method according to claim 3, further characterized in that the mean traffic loss (mean loss) is checked against a reference value.

5. The method according to claim 1, further characterized in that the analysis considers the failure of at least one network element in the section.

6. The method according to claim 5, further characterized in that the analysis additionally considers the capacity of at least one other network element in the section after consideration of the failure.

7. The method according to claim 1, further characterized in that the section is cut after a weighting of the network elements relative to their failure probability.

8. The method according to claim 1, further characterized in that the section is cut after a weighting of the network elements relative to a deviation from a mean value of the failure probability of the network elements.

9. The method according to claim 1, further characterized in that the section is cut after a weighting of the network elements relative to a deviation from a mean value of the capacity of the network elements.

10. The method according to claim 1, further characterized in that the analysis of the network elements affected by the section is made in an iterative process.

11. The method according to claim 1, further characterized in that this comprises the further step of setting up and/or adapting the data network corresponding to a network model that was optimized based on the verification results.

12. The method according to claim 1, further characterized in that the data network represents a wireless network.

13. A computer program product, with a computer-readable program medium, which, when the program is loaded, has program means for conducting the method according to claims 1.

14. A computer program product, with a computer-readable program medium, which, when the program is loaded, has program means for conducting the method according to claim 2.

15. A computer program product, with a computer-readable program medium, which, when the program is loaded, has program means for conducting the method according to claim 3.

16. A computer program product, with a computer-readable program medium, which, when the program is loaded, has program means for conducting the method according to claim 4.

17. A computer program product, with a computer-readable program medium, which, when the program is loaded, has program means for conducting the method according to claim 5.

18. A computer program product, with a computer-readable program medium, which, when the program is loaded, has program means for conducting the method according to claim 6.

19. A computer program product, with a computer-readable program medium, which, when the program is loaded, has program means for conducting the method according to claim 7.

20. A computer program product, with a computer-readable program medium, which, when the program is loaded, has program means for conducting the method according to claim 8.

21. A computer program product, with a computer-readable program medium, which, when the program is loaded, has program means for conducting the method according to claim 9.

22. A computer program product, with a computer-readable program medium, which, when the program is loaded, has program means for conducting the method according to claim 10.

23. A computer program product, with a computer-readable program medium, which, when the program is loaded, has program means for conducting the method according to claim 11.

24. A computer program product, with a computer-readable program medium, which, when the program is loaded, has program means for conducting the method according to claim 12.
